(19) United States
(12) Patent Application Publication
(10) Pub. No.: US 2023/0331337 A1
(43) Pub. Date: Oct. 19, 2023

(54) Displacement Compensating Transition Element

(71) Applicant: Canyon Bicycles GmbH, Koblenz (DE)

(72) Inventors: Michael Adomeit, Koblenz (DE); Lukas Birr, Bonn (DE)

(21) Appl. No.: 18/134,147

(22) Filed: Apr. 13, 2023

(30) Foreign Application Priority Data
Apr. 14, 2022 (DE) 20 2022 102 017.5

(51) Int. Cl. B62K 21/22; B62K 21/06

(52) U.S. Cl. CPC B62K 21/22; B62K 21/06

(57) ABSTRACT

A transmission element for arrangement between a handlebar stem and an upper headset includes a cover ring which, in the mounted state, covers an upper headset. An intermediate ring surrounding a head tube is arranged above the cover ring. To compensate for clearance changes of the headsets, a pretensioning element is arranged between the cover ring and the intermediate ring.

### CROSS-REFERENCE TO RELATED APPLICATION

This application claims priority to German Patent Application No. 20 2022 102 017.5 filed Apr. 14, 2022, the disclosure of which is hereby incorporated by reference in its entirety.

### BACKGROUND OF THE INVENTION

### Field of the Invention

The invention relates to displacement compensating transition element for arrangement between a handlebar stem of a bicycle and particularly an upper headset.

### Description of Related Art

The front wheel fork of a bicycle is rotatable supported in the steer tube of the bicycle frame. To this end, an upper and a lower headset are provided which surround the head tube at the front wheel fork and are arranged in the steer tube. It is necessary to adjust the clearing of the headsets. This is usually performed by first loosening a stem clamp by which the stem is fixed to the head tube. Thereafter, the bearing clearance is adjusted using an adjusting screw. In doing so, in order to adjust the bearing clearance, the stem clamp is displaced relative to the head tube. Intermediate elements such as spacers may possibly be arranged between a lower side of the stem clamp and an upper side of the upper headset.

The clearance may increase due to, for example, subsidence effects, abrasion or the like. This results in the formation of an undesired axial clearance. Often, this clearance increases with time, so that an adverse influence on the riding behavior may result therefrom. If the clearance is excessive, damage to components, in particular the upper headset, may occur.

### SUMMARY OF THE INVENTION

It is an object of the invention to provide a transmission element for arrangement between a handlebar stem and a headset, by which the risk of an increase in bearing clearance is reduced.

According to the invention, the object is achieved by a transmission element having the features as described herein.

The transmission element of the present invention serves to be arranged between a handlebar stem and, in particular, an upper headset. Here, when in the mounted state, the transmission element surrounds the head tube preferably completely. Intermediate elements, such as distance rings, spacers or the like, may be arranged both between the transmission element and the handlebar stem and between the transmission element and the headset. According to the invention, the transmission element comprises a cover ring as well as an intermediate ring. In the mounted state, the cover ring is arranged above the headset and covers the headset either directly or indirectly, depending on whether spacers or the like are arranged between the cover ring and the headset. The cover ring is preferably a complete ring closed in itself, while a ring segment-shaped design of the cover ring is also possible. In the mounted state, the intermediate ring surrounds the head tube and is arranged between the cover ring and the transmission element. In a preferred embodiment, the intermediate ring again is a completely closed ring. It is preferred that the cover ring and the intermediate ring are arranged coaxially with respect to one another.

According to the invention, a pretensioning element is arranged between the cover ring and the intermediate ring. The pretensioning element causes the cover ring and the intermediate ring to be pushed apart. The pretensioning element thus generates corresponding forces, which act in the axial direction with respect to the head tube. As such, the pretensioning element exerts a force on the upper bearing in the mounted state.

For mounting, the stem is loosened, as usual, so that the same is no longer fixedly connected to the head tube. Thereafter, the bearing clearance is adjusted via a corresponding screw or another tensioning element. In this mounted state, the pretensioning element is pretensioned or compressed. If the bearing clearance should become larger with time, e.g. due to subsidence effects or the like, the pretensioning element counteracts an increase in the bearing clearance and thus compensates for the same. Thus, an increase in the bearing clearance is avoided, at least in certain regions, due to the pretensioning element. Depending on the design of the pretensioning element, a change in bearing clearance of e.g. 1 mm to 2 mm can be compensated for.

In a preferred embodiment, the pretensioning element is an elastic element, wherein it is particularly preferred that the pretensioning element comprises a spring element and in particular consists of one or more spring elements. Thereby, a corresponding pretensioning force can be applied in a simple manner. Furthermore, it is preferred that the pretensioning element is designed in an annular shape, preferably one or more complete rings. Here, it is particularly preferred that the pretensioning element comprises one or more annular corrugated disks. In the mounted state, these preferably surround the head tube.

As an alternative to the preferred designs as annular spring elements, in particular corrugated disks, a plurality of coil springs distributed, in particular regularly, over the circumference and/or an elastomer body or the like may be provided as the pretensioning element, with combinations of different spring elements and the like being possible as well.

In a preferred development of the invention, the cover ring has a tab or protrusion on an upper side directed towards the pretensioning element. The same serves to adjust and, if need be, to pretension the pretensioning element.

A lower side of the cover ring, i.e. the side of the cover ring that faces to the upper headset in the mounted state, is planar in the preferred embodiment. In this manner, it is ensured in particular that the lower side of the cover ring rests flat on the headset or a ring element arranged therebetween, so that a uniform force transmission is secured.

In a particularly preferred development of the invention, the intermediate ring comprises a groove or recess in a lower side facing to the pretensioning element. The same serves to receive the pretensioning element at least in part. In this manner, the pretensioning element is adjusted in its position on the one hand, and is covered on the other hand, and is thereby also protected against contaminations, for example. In an in particular circular intermediate ring, the groove or recess is preferably also annular and circumferential. The groove or recess may be open to the inner side, i.e. towards the head tube and towards the pretensioning element. As such, the groove or recess is embodied by an in particular annular protrusion, i.e. a protrusion that is external with respect to the circumference of the intermediate ring.

In a preferred embodiment, the intermediate ring covers the cover ring in a fully pretensioned position, i.e. in the position in which the pretensioning element is in particular fully compressed. Here, the covering is effected in particular due to the provision of the groove or the external annular protrusion on the intermediate ring. As such, it is preferred that the groove has a depth that is deeper than the thickness of the fully pretensioned pretensioning element. Thereby, not only the pretensioning element, but also the cover ring is covered at least in part in the longitudinal direction or in the axial direction of the head tube.

It is further preferred that the cover ring has a mark, e.g. a color mark or the like. With the pretensioning element fully pretensioned, this mark is covered by the intermediate ring and is thus not visible. If the bearing clearance increases and is compensated by the pretensioning element, the distance between the cover ring and the intermediate ring increases, whereby, in the preferred embodiment, the mark becomes visible at least in part. This is advantageous in that it is visible in a simple manner that the bearing clearance has increased or an increase has been compensated by the pretensioning element. Therefore, the bearing clearance should be readjusted upon the next inspection or maintenance, if necessary. Due to the invention, an immediate readjustment is no longer necessary.

The above described configuration of the intermediate ring and the cover ring, in particular with respect of the groove or recess and a corresponding covering of the pretensioning element and/or the cover ring, as well as the mark, may also be inversed, so that a kinematic inversion between these elements of the components is possible.

In a preferred development, the intermediate ring is positively connected with a handlebar stem. This may be achieved via e.g. protrusions, such as pins or the like that extend into corresponding recesses. Irrespectively, the upper side of the intermediate ring may be inclined with respect to a lower side of the intermediate ring facing to the pretensioning element. In particular, the distance of the upper surface to the lower surface decreases in the traveling direction in the mounted state.

The invention further relates to a steering system of a bicycle. The same comprises a front wheel fork with a head tube that is arranged in a steer tube of the bicycle frame. Two headsets are arranged inside the steer tube, which surround the head tube and allow the head tube to be rotated in the steer tube. The transmission element of the invention is arranged in the region of the upper end of the head tube. Above the transmission element, the handlebar stem is releasably connected to the head tube. Further, a tensioning element in the form of a tensioning screw is possibly provided for adjusting the bearing clearance. The transmission element is developed preferably as described above.

### BRIEF DESCRIPTION OF THE DRAWINGS

In the following, the invention is described in more detail by means of a preferred embodiment with reference to the accompanying drawings.

In the Figs.:

FIG. 1 shows a schematic perspective view of the components of the transmission element,

FIG. 2a shows a schematic side view of the assembled transmission element in a fully pretensioned state,

FIG. 2b shows a schematic side view of the assembled transmission element in a partly released state,

FIGS. 3a and 3b are illustrations corresponding to FIGS. 2a and 2b, with the intermediate ring being shown in section for clarity.

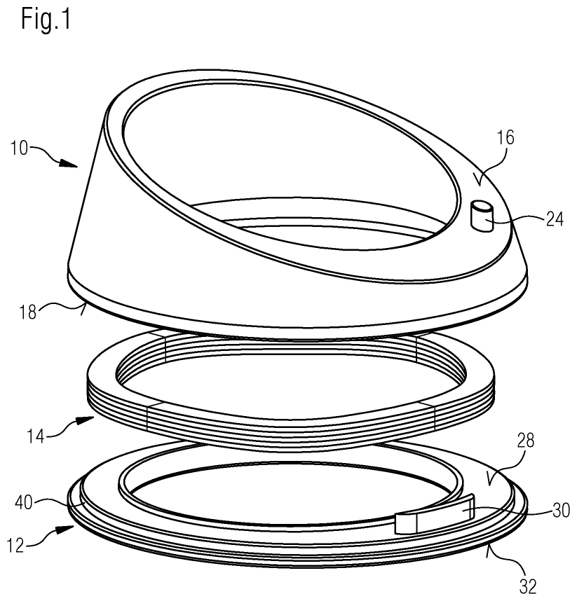

### DESCRIPTION OF THE INVENTION

In the embodiment illustrated, the transmission element has an intermediate ring 10 as well as a cover ring 12. A pretensioning ring 14 is arranged between the intermediate ring 10 and the cover ring 12. In the embodiment illustrated, the pretensioning element 14 comprises a plurality of stacked corrugated disks. The cover ring 10 may also be designed as a cover cap, depending on the design of the stem and the type of pretensioning of the headsets.

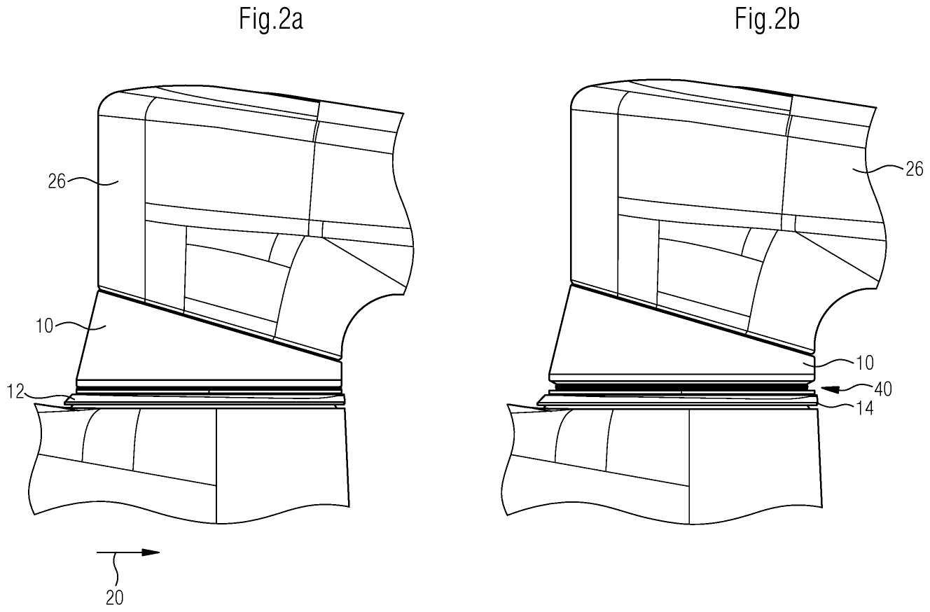

In the embodiment illustrated, the intermediate ring 10 is trapezoidal or wedge-shaped in side view, so that an upper side 16 of the intermediate ring 10 is inclined with respect to a lower side 18 of the intermediate ring 10. The distance between the surfaces 16, 18 decreases in the traveling direction 20 (FIG. 2a).

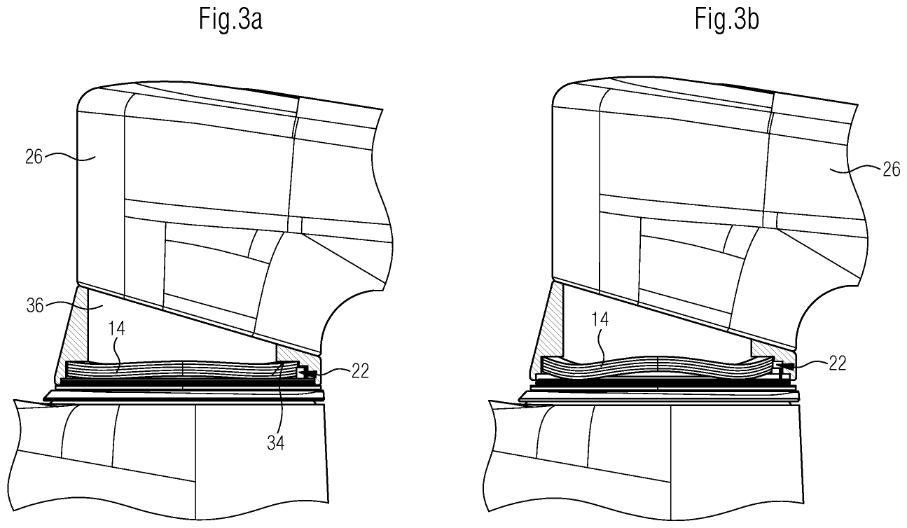

For receiving the pretensioning element 14 comprising a plurality of corrugated disks, the intermediate ring has a groove or recess 22 in its lower side 18 (FIG. 3a). Further, in the embodiment illustrated, the intermediate ring has an adjustment pin 24 on the upper side 16, which engages into an opening of the stem 26, not illustrated, for a positive connection with the stem 26.

The cover ring 12 has an upper side 28 facing to the pretensioning ring 14. In the mounted state (FIGS. 3a and 3b), the pretensioning element 14 rests on the same at least in part. In the embodiment illustrated, the upper side 28 of the cover ring 12 further has a protrusion 30 for adjusting and/or pretensioning the pretensioning element 14. Further, the cover ring 12 is stepped and thus has a larger ring on an lower side 32. The lower side 32 rests on the upper headset, possibly with interposition of distance rings (spacers). In the mounted state, the pretensioning element 14 rests, on the one hand, on the upper side 28 of the cover ring 12 and on the other hand, in the abutment surface 34 formed by the groove or recess 22 (FIG. 3a).

For assembly, the stem 26, which is connected to a head tube 36 via clamping elements or the like, not illustrated, is loosened. Thereafter the bearing clearance can be adjusted by means of a screw extending in particular in the longitudinal direction of the head tube 36 and abutting an upper region 38 of the stem 26.

After the headsets have been adjusted or pretensioned, the handlebar stem 26 is clampingly fixed to the head tube 36 again.

In the folly pretensioned position (FIGS. 2a and 3a), the pretensioning element 14 is compressed. The cover ring 12 has a small distance from the intermediate ring 10, if any. If the bearing clearance increases, the same is compensated by the pretensioning element, with the position of the pretensioning element 14 changing to the position illustrated in FIGS. 2b and 3b, for example. Thereby, the distance between the cover ring 14 and intermediate ring 10 becomes larger, so that a mark 40, which in the embodiment illustrated is a color mark, becomes visible (FIG. 2b).

1. A transmission element for arrangement between a handlebar stem and, in particular, an upper headset, comprising
a cover ring covering an upper headset in the mounted state,
an intermediate ring surrounding a head tube, preferably completely, in the mounted state, and
a pretensioning ring arranged between the cover ring and the intermediate ring.

2. The transmission element according to claim 1, wherein the pretensioning element comprises at least one spring element.

3. The transmission element according to claim 1, wherein the pretensioning element is annular in shape.

4. The transmission element according to claim 1, wherein the pretensioning element comprises at least one corrugated disk.

5. The transmission element according to claim 1, wherein the cover ring has a protrusion on an upper side facing to the pretensioning element.

6. The transmission element according to claim 1, wherein the cover ring has a planar lower side facing to the upper headset.

7. The transmission element according to claim 1, wherein the intermediate ring has a groove or recess for receiving the pretensioning element, said groove or recess being formed in a lower side (18) facing to the pretensioning element.

8. The transmission element according to claim 1, wherein in the fully pretensioned position, the intermediate ring laterally covers the cover ring at least partly.

9. The transmission element according to claim 7, wherein the groove or recess has a depth that is deeper than the thickness of the fully pretensioned pretensioning element.

10. The transmission element according to claim 7, wherein the cover ring comprises a mark which is covered by the intermediate ring when the pretensioning element is fully pretensioned, and is visible when the pretensioning element is only partly pretensioned.

11. The transmission element according to claim 1, wherein the intermediate ring is positively connected to a handlebar stem.

12. The transmission element according to claim 1, wherein an upper side of the intermediate ring is inclined with respect to a lower side of the intermediate ring facing to the pretensioning element.
